(19) United States
(12) Patent Application Publication
(10) Pub. No.: US 2016/0203703 A1
(43) Pub. Date: Jul. 14, 2016

(54) Pet Emergency Notification System

(71) Applicant: VineLight, LLC, LaVista, NE (US)

(72) Inventor: Paul Kent Graeve, Dadeville, AL (US)

(73) Assignee: VINELIGHT, LLC, LaVista, NE (US)

(21) Appl. No.: 14/667,401

(22) Filed: Mar. 24, 2015

Related U.S. Application Data
(60) Provisional application No. 62/101,792, filed on Jan. 9, 2015.

(51) Int. Cl. G08B 25/10; H04W 4/22

(52) U.S. Cl. CPC G08B 25/10; H04W 4/22

(57) ABSTRACT

An emergency notification system is provided. The emergency notification system may include an emergency server configured to receive emergency information including address information corresponding to a reported emergency, and an emergency database that stores registered user information. Upon receipt of emergency information including address information corresponding to a reported emergency, the emergency server queries the emergency database to determine whether any registered user information contains an address that matches the address information contained in the received emergency information. If the emergency server determines that an address contained in the registered user information matches the address information contained in the received emergency information, the emergency server provides an emergency notification to a user associated with the address.

### CROSS REFERENCE TO RELATED APPLICATION

This application claims the benefit of U.S. Provisional Patent Application No. 62/101,792, filed on Jan. 9, 2015, which is incorporated herein by reference in its entirety.

### BACKGROUND

The present disclosure generally relates to an emergency notification system, and more specifically to an emergency notification system that facilitates the rescue of pets.

Every year thousands of pets die in various emergencies, such as house fires. Although emergency notification systems that notify police, fire department, and rescue personnel are well-known, such notification systems do not notify the authorities of the presence of pets that may be trapped inside the building. Nor do such notification systems notify neighbors who may be able to rescue the pets or at least open a window or door for the pet to escape before rescue personnel arrive. Accordingly, there is a need for an emergency notification system that facilitates the rescue of pets from emergency situations.

### SUMMARY

According to an aspect of one or more exemplary embodiments, there is provided a system including an emergency server configured to receive emergency information including address information corresponding to a reported emergency, and an emergency database that stores registered user information. Upon receipt of emergency information including address information corresponding to a reported emergency, the emergency server queries the emergency database to determine whether any registered user information contains an address that matches the address information contained in the received emergency information. If the emergency server determines that an address contained in the registered user information matches the address information contained in the received emergency information, the emergency server provides an emergency notification to a user associated with the address.

According to another aspect of one or more exemplary embodiments, there is provided an emergency notification system including a mobile application configured to be installed on a user's device, and one or more smart detectors installed in a dwelling and configured to detect at least one of heat and smoke, and configured to communicate with the mobile application of the user associated with the dwelling. If the one or more smart detectors detects a fire, the one or more smart detectors transmits a rescue alert to the mobile application of the user associated with the dwelling.

According to another aspect of one or more exemplary embodiments, there is provided an emergency notification system including a group mobile application configured to be installed on devices of users residing in a multi-unit dwelling and a plurality of smart detectors installed in a plurality of units in the multi-unit dwelling, which are configured to detect at least one of heat and smoke, wherein the plurality of smart detectors are configured to communicate with the group mobile application. If one or more smart detectors detects a fire, the one or more smart detectors transmits a rescue alert to the group mobile application.

According to yet another aspect of one or more exemplary embodiments, there is provided a pet care notification system including a mobile application configured to be installed on a user's device and to receive information relating to caring for one or more of the user's pets, and a pet care database that stores the information relating to caring for one or more of the user's pets. The mobile application notifies the user and/or the pet owner (if the two are different) when a task is due or overdue based on the information relating to caring for the one or more pets.

According to yet another aspect of one or more exemplary embodiments, there is provided a pet safety system including a mobile application configured to be installed on a user's device, and a vehicle monitoring device installed in the user's vehicle that monitors acceleration of the user's vehicle. The mobile application may include a module configured to communicate with the vehicle monitoring device, and to communicate with one or more smart pet tracker devices that indicates a pet location. The mobile application determines whether one or more pets are located in the user's vehicle based on a signal received from the one or more smart pet tracker devices. If the mobile application determines that one or more pets is located in the vehicle, the mobile application alerts the user that the one or more pets is located in the vehicle if the mobile application determines that the user is more than a predetermined distance away from the vehicle The vehicle monitoring device may also detect when the vehicle has been in an accident based on, for example, the deceleration of the vehicle or deployment of the vehicle's airbags. In addition, the vehicle monitoring device may also include a wireless transmitter that is capable of notifying emergency personnel if an accident has been detected.

According to yet another aspect of one or more exemplary embodiments, there is provided an automated pet door system including a pet mobile application installed on a user's device, and one or more smart door opener devices installed on one or more doors at the user's residence, and configured to automatically open the one or more doors. The pet mobile application may include a module configured to allow the user to specify a schedule according to which the user's pet is allowed to enter or exit the one or more doors at the user's residence, and a module configured to communicate the schedule to the one or more smart door opener devices. The one or more smart door opener devices opens one or more doors in accordance with said schedule.

### BRIEF DESCRIPTION OF DRAWINGS

FIG. 1 is a block diagram and flowchart of a process of initiating an emergency notification using a pet emergency notification system according to an exemplary embodiment.

FIG. 2 is a block diagram and flowchart of a process of initiating an emergency notification using a pet emergency notification system according to another exemplary embodiment.

FIG. 3 is a block diagram and flowchart of a process of initiating an emergency notification using a pet emergency notification system according to yet another exemplary embodiment.

FIG. 4 is a block diagram and flowchart of a process of initiating an emergency notification using a pet emergency notification system according to yet another exemplary embodiment.

FIG. 5 is a block diagram and flowchart of a process of determining whether a pet is involved in the emergency and if so sending the appropriate notification, according to an exemplary embodiment.

FIG. 6 is a flowchart showing a process of responding to a pet emergency notification according to an exemplary embodiment.

FIG. 7 is a flowchart showing a process of registering for the pet emergency notification system according to an exemplary embodiment.

FIG. 8 is a flowchart of a process for using a pet emergency notification system with other smart home devices to facilitate a pet rescue, according to an exemplary embodiment.

FIG. 9 is a flowchart of a process for using a pet emergency notification system with other smart home devices to facilitate a pet rescue, according to another exemplary embodiment.

FIG. 10 is a flowchart of a process for using a pet emergency notification system with other smart home devices to facilitate a pet rescue, according to yet another exemplary embodiment.

FIG. 11 is a flowchart of a process for using a pet emergency notification system with other smart home devices to facilitate a pet rescue, according to yet another exemplary embodiment.

FIG. 12 is a flowchart of a process for using a pet emergency notification system with other smart home devices to facilitate a pet rescue, according to yet another exemplary embodiment.

FIG. 13 is a flowchart of a process for using a pet emergency notification system according to an exemplary embodiment, which functions while the pet is not at the pet owner's residence.

FIG. 14 is a flowchart of a process for using a pet emergency notification system according to an exemplary embodiment to rescue pets from a vehicle accident.

FIG. 15 is a flowchart of a process for using a pet emergency notification system according to an exemplary embodiment to function as an automated dog door.

### DETAILED DESCRIPTION OF EXEMPLARY EMBODIMENTS

Reference will now be made in detail to the following exemplary embodiments, which are illustrated in the accompanying drawings, wherein like reference numerals refer to like elements throughout.

The exemplary embodiments may be embodied in various forms without being limited to the exemplary embodiments set forth herein. Descriptions of well-known parts are omitted for clarity.

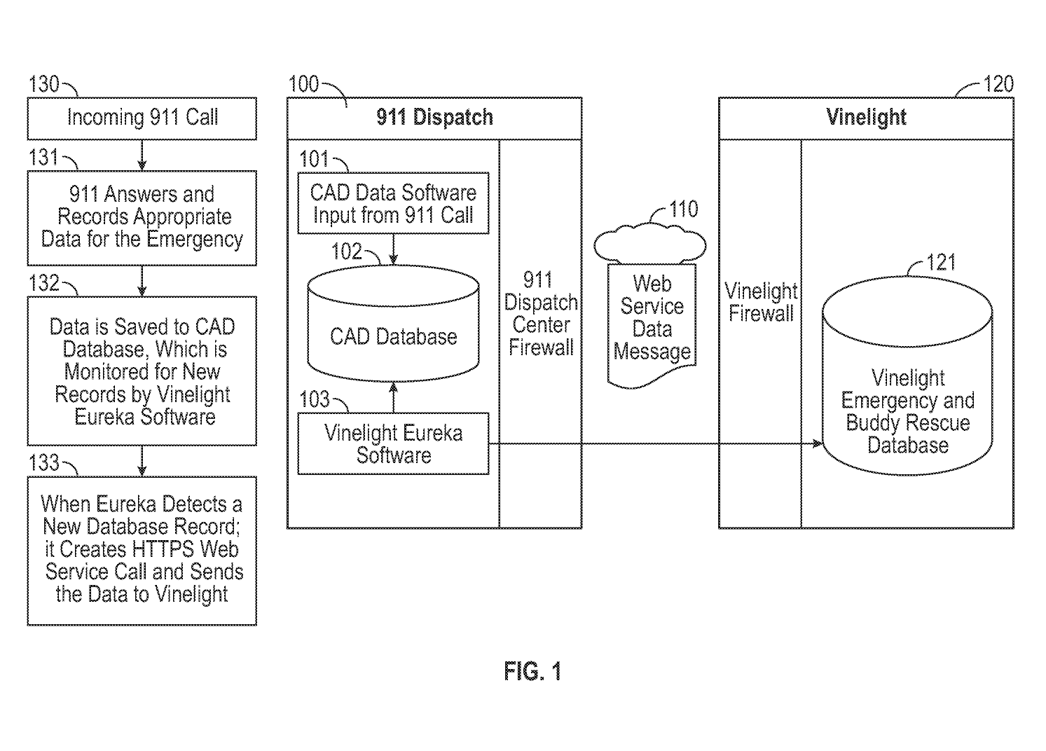

FIG. 1 is a block diagram and flowchart of a pet emergency notification system and a method of initiating a notification according to an exemplary embodiment. Referring to FIG. 1, the pet emergency notification system of the exemplary embodiment includes 911 dispatch system 100 and a Vinelight system 120. 911 dispatch system 100 includes a computer-aided dispatch (CAD) database 102 and Vinelight Eureka software 103. The Vinelight server 120 includes a Vinelight emergency and buddy rescue database 121.

In step 130, a 911 call is received reporting an emergency. In step 131, a 911 operator records information relating to the emergency, such as the caller's name, the location of the emergency, the type of emergency, whether anyone is injured, etc. In step 132, the data input by the 911 operator 101 is saved to CAD database 102, which is monitored by the Vinelight Eureka software 103. In step 133, the Vinelight Eureka software detects that a new database record has been created in CAD database 102, and creates a web service data message 110 that is sent via the Internet to the Vinelight server 120. The web service data message is then stored in the Vinelight emergency buddy rescue database 121.

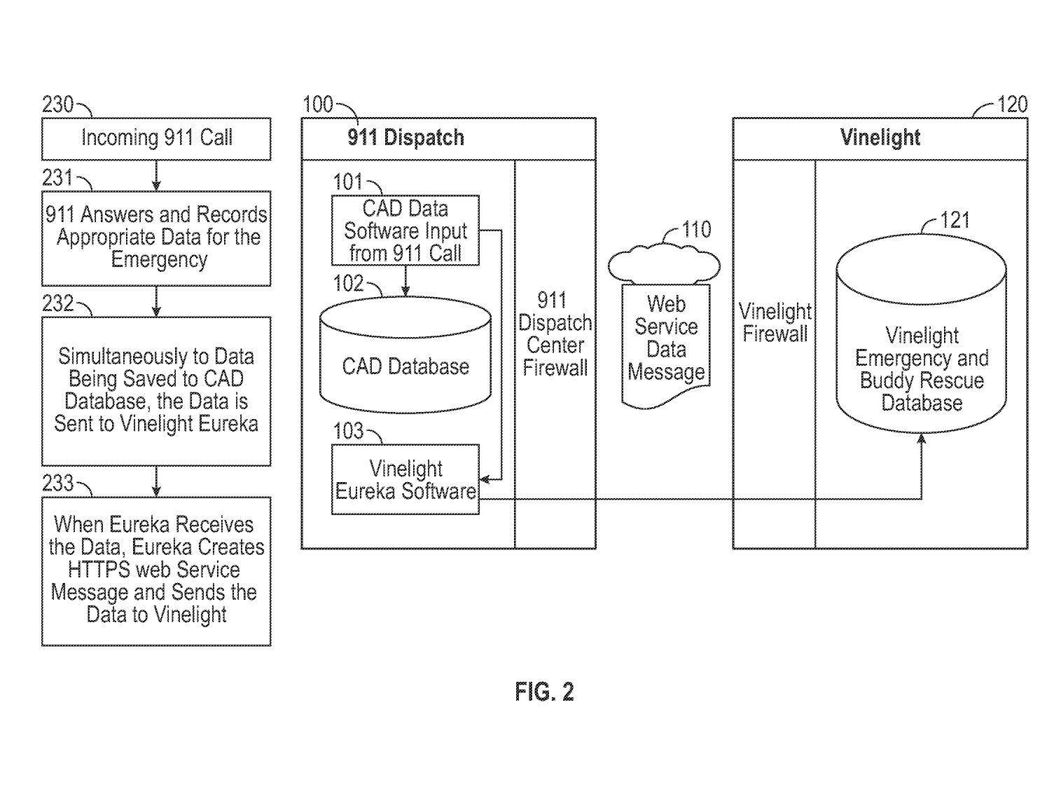

FIG. 2 is a block diagram and flowchart of a pet emergency notification system and a method of initiating a notification according to another exemplary embodiment. Referring to FIG. 2, the components of the emergency notification system are the same as those discussed above in conjunction with FIG. 1. In addition, steps 230 and 231 of FIG. 2 are identical to steps 130 and 131, respectively, of FIG. 1. However, the method of initiating the emergency notification differs from that of FIG. 1 in that instead of the Vinelight Eureka software 103 detecting a new record in CAD database 102, in step 232 of FIG. 2 the data input by the 911 operator 101 is simultaneously saved to the CAD database 102 and transmitted to the Vinelight Eureka software 103. In step 233, the Eureka software 103 creates a web service message and sends the message to the Vinelight server 120.

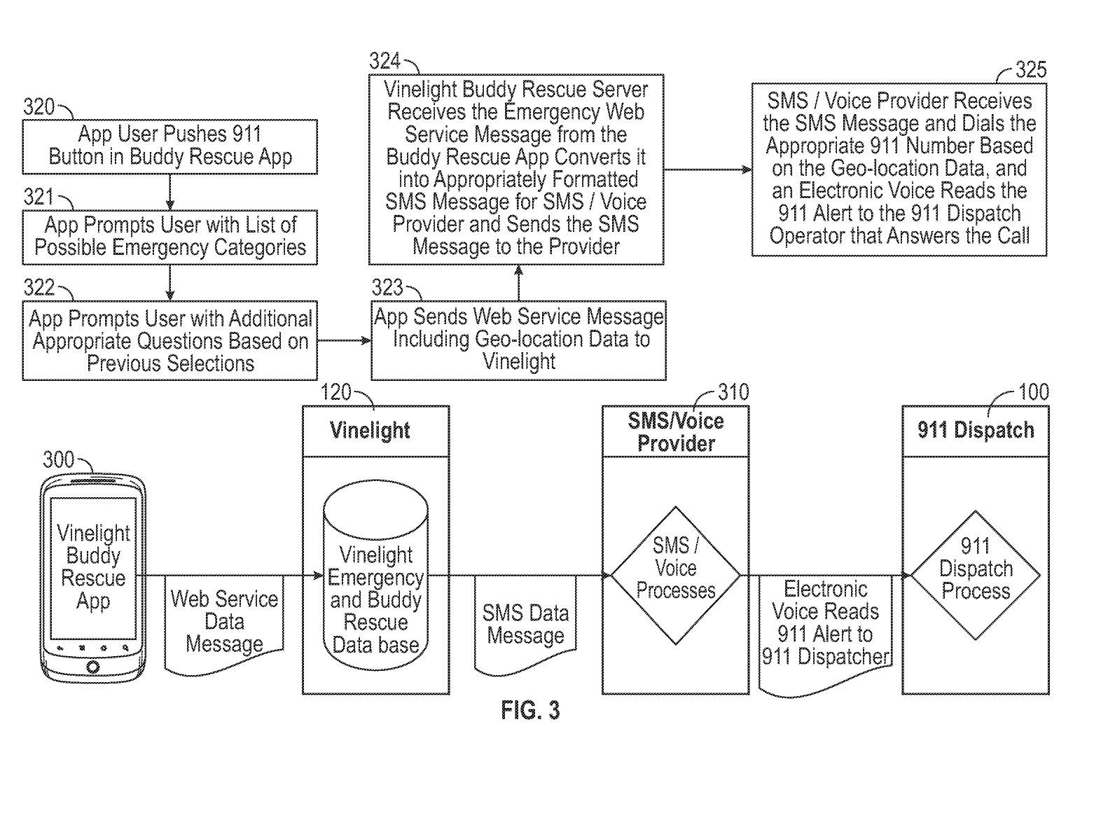

FIG. 3 is a block diagram and flowchart of a pet emergency notification system and a method of initiating a notification according to yet another exemplary embodiment. Referring to FIG. 3, the exemplary embodiment includes a Vinelight buddy rescue mobile application 300 that may be installed on a user's mobile device, such as a mobile telephone, tablet, etc. The Vinelight buddy rescue mobile application may include a graphical user interface having an emergency notification function that allows the user to trigger an emergency notification. The Vinelight buddy rescue mobile application may be a downloadable application that functions on an iOS, Android, or other operating system. In step 320, the user selects the emergency notification option, for example, a 911 button on the graphical user interface. In step 321, the Vinelight buddy rescue mobile application 300 displays a list of possible emergency categories from which the user may select. In step 322, the user selects one or more of the displayed categories that best describe the emergency the user is attempting to report. The app may then provide follow-up questions or options for the user to answer or select based on the user's previous selection of one or more emergency categories. For example, if the user selects the category indicating a fire emergency, the Vinelight buddy rescue mobile application 300 may then provide follow-up options for the user to indicate if any people or animals are inside the building, and if so, descriptions of the people or animals.

In step 323, the Vinelight buddy rescue mobile application 300 sends a web service data message to the Vinelight server 120, containing the information input by the user. The web service data message may also include the user's geo-location information that may be collected by, for example, a GPS receiver located in the user's mobile device. In step 324, the Vinelight server 324 receives the emergency web message from the Vinelight buddy rescue mobile application 300 and converts the web service data message into an appropriately formatted short message service (SMS) message, or other type of similar data message, and sends the message to SMS/voice provider 310. In step 325, the SMS/voice provider receives the SMS message and dials the appropriate number to alert rescue personnel of the emergency. For example, the SMS/voice provider may call the local 911 operator based on the user's geo-location information received from the Vinelight server 120. In the exemplary embodiment of FIG. 3, an automated voice may read the relevant emergency information to the 911 operator to report the emergency. Alternatively, the SMS/voice provider 310 may transmit the relevant emergency information to the 911 dispatch 100 via other means, such as email, text message, etc.

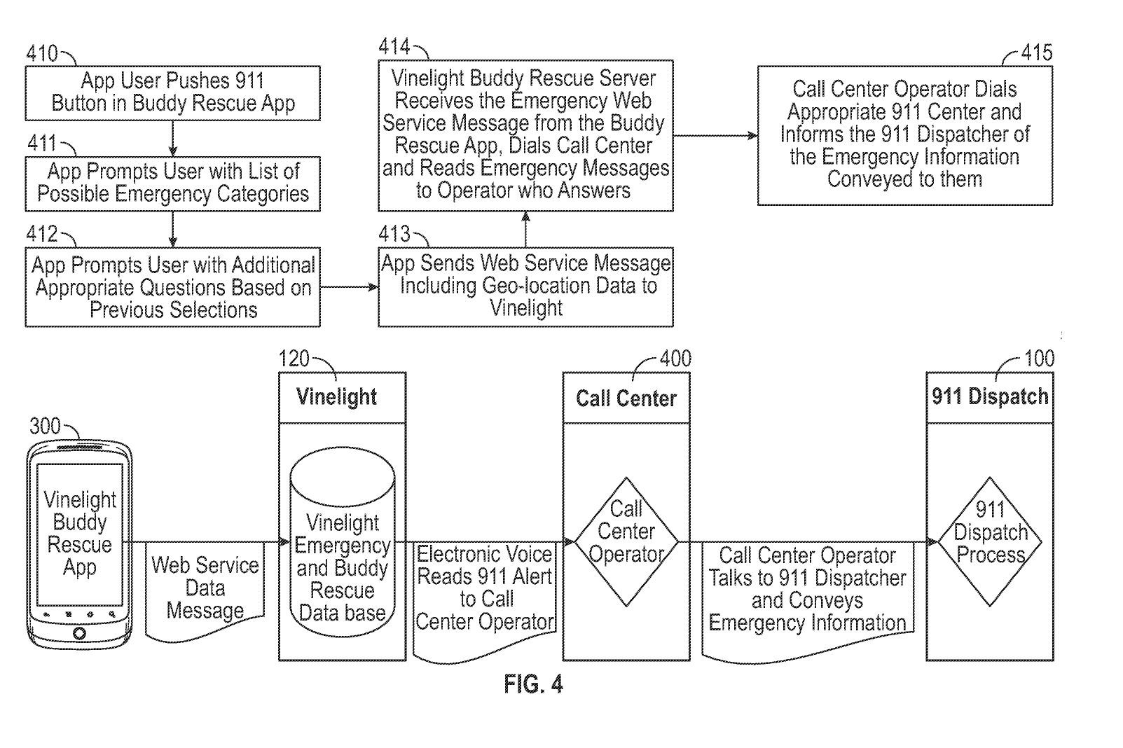

FIG. 4 is a block diagram and flowchart of a pet emergency notification system and a method of initiating a notification according to yet another exemplary embodiment. The exemplary embodiment of FIG. 4 is similar to the exemplary embodiment of FIG. 3, however, instead of utilizing SMS/voice provider 310, the exemplary embodiment of FIG. 4 includes a call center 400. Steps 410, 411, 412, and 413 are identical to steps 320, 321, 322, and 323 of FIG. 3, respectively, and therefore will not be reiterated here. In step 414, the Vinelight server 120 receives the emergency web service data message from the Vinelight buddy rescue mobile application 300, initiates a call to call center 400, and reads the emergency message to an operator at the call center 400. Alternatively, the Vinelight server 120 may transmit the relevant emergency notification information to the call center 400 via other means, such as email, text message, etc. In step 415, the operator at call center 400 calls the appropriate emergency rescue personnel, e.g., 911 dispatcher, and informs the dispatcher of the relevant emergency information so that the dispatcher can dispatch the appropriate rescue personnel.

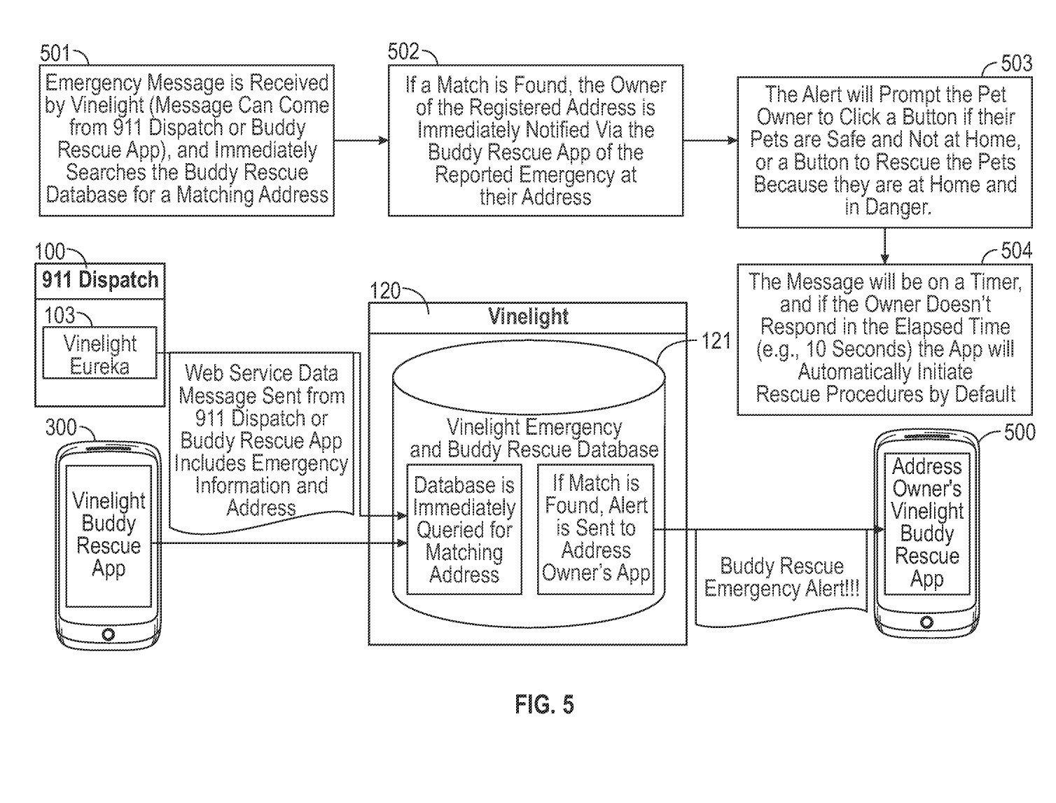

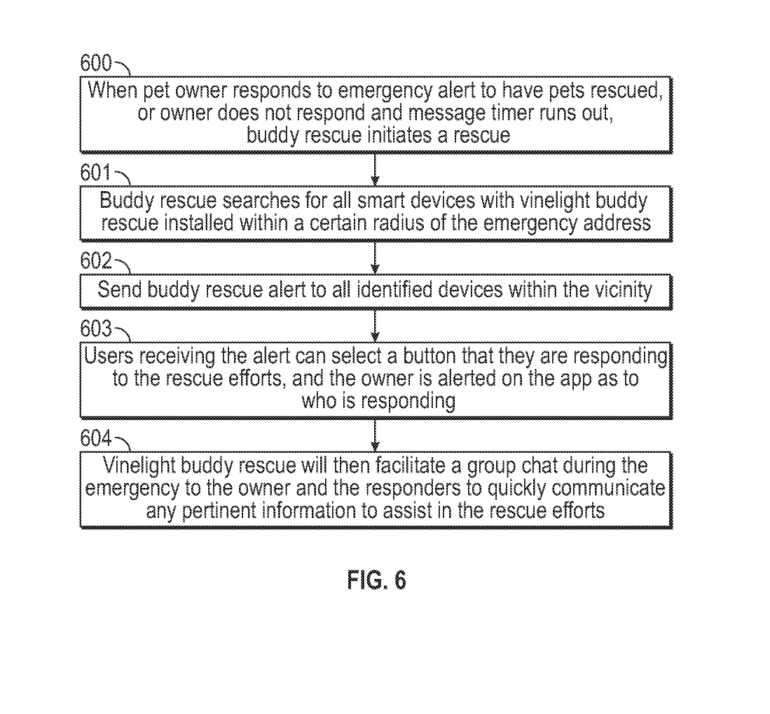

FIG. 5 is a block diagram and flowchart illustrating how the emergency notification system processes a received emergency notification according to an exemplary embodiment. In step 501, the Vinelight server 120 receives an emergency message from 911 dispatch 100 or the Vinelight buddy rescue mobile application 300, and searches the Vinelight emergency buddy rescue database 121 to determine whether the address information contained in the received emergency message matches a previously registered address in the Vinelight emergency buddy rescue database 121. If no matching address is found, the process ends. However, if a matching address is found, in step 502 the owner associated with the registered address is notified via the Vinelight buddy rescue mobile application 300 that an emergency has been reported at the owner's address. If the owner is on a voice call at the time the notification is received, the Vinelight buddy rescue mobile application 300 may interrupt the voice call to inform the owner of the emergency. In step 503, the Vinelight buddy rescue mobile application 300 prompts the owner to select whether the owner's pets are safe and not at home, or that the pets are home and a rescue should be initiated. In step 504, the Vinelight buddy rescue mobile application 300 waits a predetermined period of time, e.g., 10 seconds, for the owner to indicate whether a rescue should be initiated. If the owner does not respond within the predetermined period of time, the Vinelight buddy rescue mobile application 300 will initiate a rescue, as described in FIG. 6.

FIG. 6 is a flowchart illustrating an exemplary embodiment of the steps taken upon receiving an indication from the user that a rescue should be initiated, or if the user fails to respond to the Vinelight buddy rescue mobile application 300 within the predetermined period of time. In step 600, the Vinelight buddy rescue mobile application 300 determines that the owner either (1) indicated that a rescue should be initiated, or (2) did not respond to the displayed prompt asking the owner whether a rescue should be initiated. In step 601, the Vinelight buddy rescue mobile application 300 searches for any devices, e.g., mobile telephones, tablets, etc., on which the Vinelight buddy rescue mobile application 300 has been installed, and which are located within a predetermined radius of the emergency address.

In step 602, the Vinelight buddy rescue mobile application 300 sends a buddy rescue alert to any devices discovered within the predetermined radius that have the Vinelight buddy rescue mobile application 300 installed. The buddy rescue alert may include various types of information related to the emergency, such as, without limitation, the address of the emergency, the name, description, and/or photograph of the pets located within the house, notes on where the pets may be located within the house or how the house may be entered, a garage key code, location of a hidden key, or any other types of information that may be helpful to a user attempting to rescue the pets from the emergency. For example, the buddy rescue alert may also include the phone number of the owner of the emergency address.

In step 603, the discovered users within the predetermined radius of the emergency are prompted by the Vinelight buddy rescue mobile application 300 to indicate whether they are responding to the rescue request. If a user indicates that he or she is responding, the Vinelight buddy rescue mobile application 300 informs the owner who is responding to the emergency. In step 604, the Vinelight buddy rescue mobile application 300 facilitates a group chat session during which one or more users attempting the rescue may communicate with each other and the owner to communicate any additional information that may be helpful in conducting the rescue.

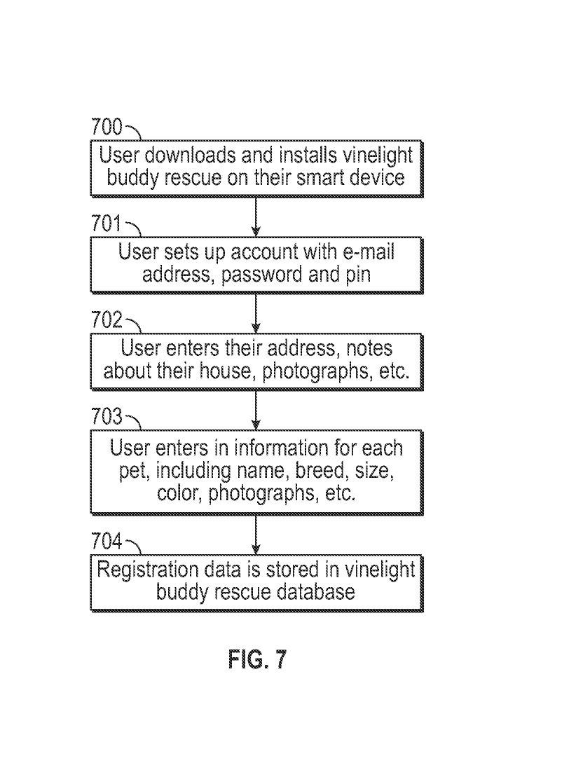

FIG. 7 is a flowchart showing a process of registering for the pet emergency notification system according to an exemplary embodiment. In step 700, the user downloads and installs the Vinelight buddy rescue mobile application 300 on the user's device. In step 701, the user establishes an account on the Vinelight buddy rescue mobile application 300 by inputting an e-mail address, password, and/or personal identification number. In step 702, the user inputs his or her address, any notes about the user's house, photographs of the house, etc. The user may also input contact information of any individuals that should be notified in the event of an emergency. For example, the user may input the phone number and/or email address of a neighbor, so that the neighbor may be notified via email, phone call, text message, etc. of an emergency at the owner's address. In step 703, the user inputs information for each pet the user would like to register. For example, the user may input information regarding the pet's name, breed, size, and/or color, and may also upload photographs of each pet. The user may also include any notes that may be helpful in a rescue situation, such as suggestions on how to best rescue the pet in an emergency situation, or where the pet likes to sleep during the day. In step 704, the data input by the user is stored in the Vinelight emergency and buddy rescue database 121.

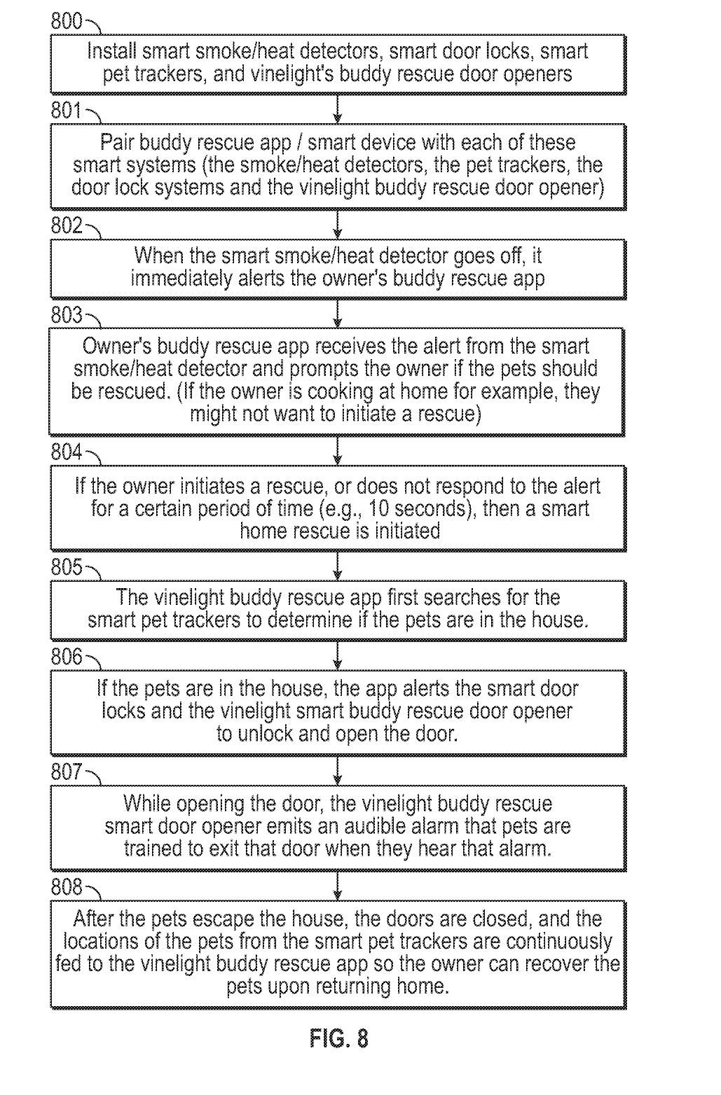

FIG. 8 is a flowchart of a process for using a pet emergency notification system with other smart home devices to facilitate a pet rescue, according to an exemplary embodiment. In step 800, the owner installs one or more “smart” home appliances in the owner's home. A “smart” home appliance may be any device that is capable of communicating with other devices, for example, via a local area network, wi-fi, Bluetooth, or any other type of wired or wireless communication medium or protocol. For example, and without limitation, smart home appliances may include smoke detectors, heat detectors, carbon monoxide detectors, door locks, door opening/closing devices, pet tracking devices, vehicle monitoring devices, and smart dog crate doors disclosed herein.

In step 801, the owner pairs the Vinelight buddy rescue mobile application 300 with one or more smart devices installed in the owner's home, which allows the smart device(s) to communicate with the Vinelight buddy rescue mobile application 300. In addition, the smart devices may be paired with a Vinelight buddy rescue mobile application 300 of the owner's neighbor, friend, family member, etc. In the exemplary embodiment of FIG. 8, the example of a smoke detector detecting smoke is described, however other types of emergencies and smart devices may be used to initiate the process. In step 802, the smart smoke detector detects heat and/or smoke and sounds an audible alarm to alert anyone in the home. The smart smoke detector also immediately transmits an alert message to the Vinelight buddy rescue mobile application 300 installed on the owner's mobile device. The smart smoke detector may also transmit an alert message to any other mobile device that has been paired with the smart smoke detector, e.g., a neighbor who may be able to respond to an emergency.

In step 803, the Vinelight buddy rescue mobile application 300 receives the alert from the smart home appliance and prompts the owner to indicate whether additional rescue measures should be taken. For example, if a smoke detector goes off while the owner is cooking but there is no fire or other danger, the owner can indicate that no additional rescue measures are needed. In step 804, the Vinelight buddy rescue mobile application 300 waits a predetermined period of time for the user to indicate whether further rescue measures are necessary. If the user does not respond within the predetermined time period, or responds by indicating such additional measures are necessary, then the process continues to step 805 to implement additional rescue measures. If the user indicates within the predetermined time period that no additional rescue is necessary, the rescue process ends.

In step 805, the Vinelight buddy rescue mobile application 300 transmits a signal to a pet tracker device affixed to the pet's collar in order to determine whether the pet is inside the house. If the pet's collar does not include a smart pet tracker device, this step may be skipped. The smart pet tracker may be a wireless GPS or RFID tag located on the pet's collar, or implanted just beneath the pet's skin. The pet tracker device receives the signal from the Vinelight buddy rescue mobile application 300 and transmits a response signal indicating the location of the pet. The response signal may indicate whether the pet is inside the house, or alternatively may indicate a physical location, such as GPS coordinates, that the Vinelight buddy rescue mobile application 300 can use to determine whether the pet is inside the house.

In step 806, if the pet is determined to be in the house, the Vinelight buddy rescue mobile application 300 transmits a signal to the home's smart door lock device and smart door opener device, which causes one or more doors of the home to be unlocked and opened. In step 807, the smart door opener may emit an audible alarm to notify the pet that the door is open. The owner may previously train the pet to exit the house upon hearing the audible alarm. During this step, the pet tracker device continuously transmits the pet's location to the Vinelight buddy rescue mobile application 300. In step 808, the Vinelight buddy rescue mobile application 300 receives a signal from the pet tracker device to determine whether the pet has exited the house. If it is determined that the pet has exited the house, the Vinelight buddy rescue mobile application 300 may transmit a signal to the smart door opener device to close the door. For example, in the case of a fire, closing the door prevents additional oxygen from entering the house to intensify the fire, and also keeps the pet from reentering the house through the open door. In addition, the Vinelight buddy rescue mobile application 300 displays the location of the pet received from the pet tracker device so that the owner can locate the pet. Once the pet has exited the house, the Vinelight buddy rescue mobile application 300 may transmit a signal to an emergency dispatch server (e.g., 911 server) indicating that the pet(s) have been rescued.

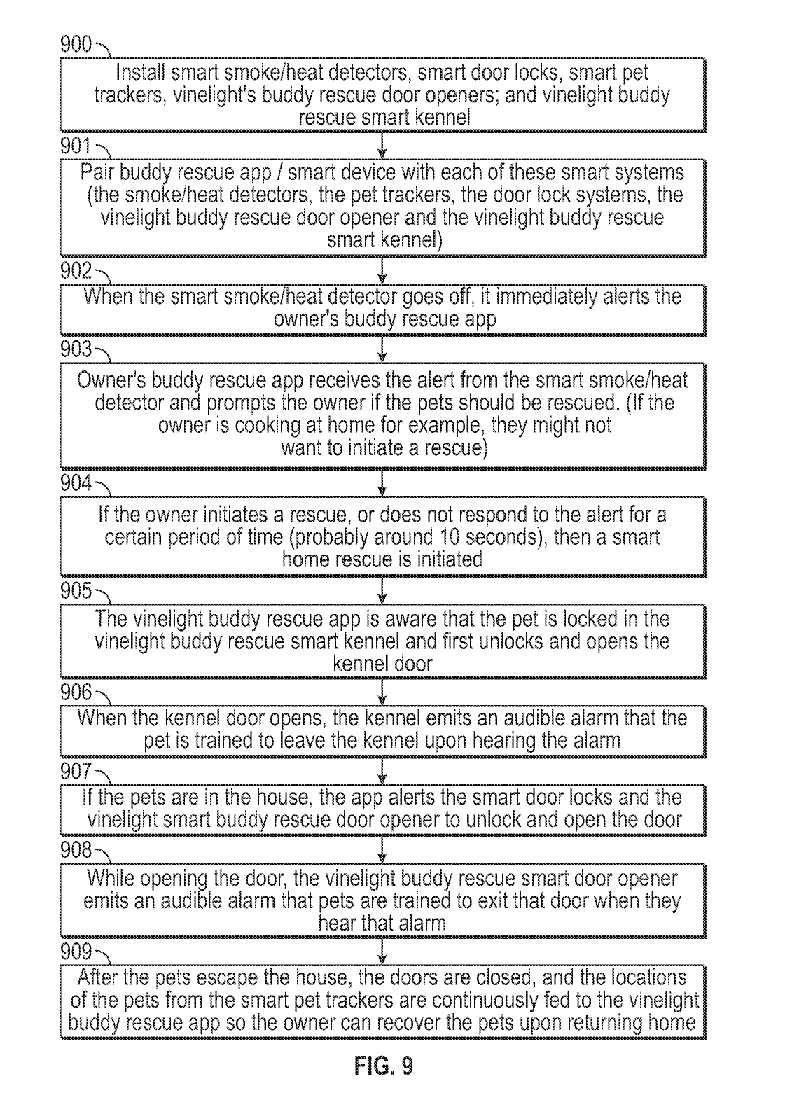

FIG. 9 is a flowchart of a process for using a pet emergency notification system with a smart pet kennel to facilitate a pet rescue, in accordance with an exemplary embodiment. FIG. 9 is similar to the method shown in FIG. 8, so a detailed description of similar steps will be omitted. Similar to steps 800 and 801 of FIG. 8, in steps 900 and 901 smart home devices are installed and paired with the Vinelight buddy rescue mobile application 300. But in the exemplary embodiment of FIG. 9, the smart home devices include a smart kennel or pet crate. For example, many pet owners leave their pets in a kennel or crate within the home while the owner is at work. In the exemplary embodiment of FIG. 8, causing the external doors of the home to open in the event of an emergency is useless if the pet is trapped in a crate or kennel. Therefore, the exemplary embodiment of FIG. 9 includes a smart kennel or crate that is able to communicate with other devices via any wireless or wired medium or protocol, and is able to open the kennel door based on a signal received thereby.

In steps 903 and 904, a smart smoke detector detects smoke and triggers an audible alarm and an alarm signal that is transmitted to the Vinelight buddy rescue mobile application 300. As in the exemplary embodiment of FIG. 8, the Vinelight buddy rescue mobile application 300 continues on to the next step in the process based on the owner's response or failure to respond within the predetermined time period. In step 905, the Vinelight buddy rescue mobile application 300 determines whether the door of the smart kennel is locked based on a status signal transmitted from the smart kennel. If the kennel door is locked, the Vinelight buddy rescue mobile application 300 transmits a signal to the smart kennel to unlock and open the kennel door. In step 906, the kennel door opens and the smart kennel emits an audible alarm intended to cause the pet to exit the kennel. In step 907, the Vinelight buddy rescue mobile application 300 transmits a signal to the smart door opener device that controls the external doors of the home, and causes the external doors to open. As in the exemplary embodiment of FIG. 8, in steps 908 and 909, an audible alarm is triggered to alert the pet to the open external door and the pet's position is relayed from the smart pet tracker device to the owner's Vinelight buddy rescue mobile application 300 so that the owner may locate the pet after it exits the home.

According to another exemplary embodiment, the smart kennel may be equipped with wheels, a motor, and a controller that controls the motor and wheels to drive the smart kennel out of the house in an emergency situation. For example, in step 905 of FIG. 9, instead of unlocking the crate, the Vinelight buddy rescue mobile application 300 may send a signal to the smart kennel causing the smart kennel to drive itself out of the house. The smart kennel may include a memory storing a layout of the house, which may be used by the controller to navigate the smart kennel out of the house. The smart kennel may also use a GPS receiver to determine its own position and navigate to a known position of a door.

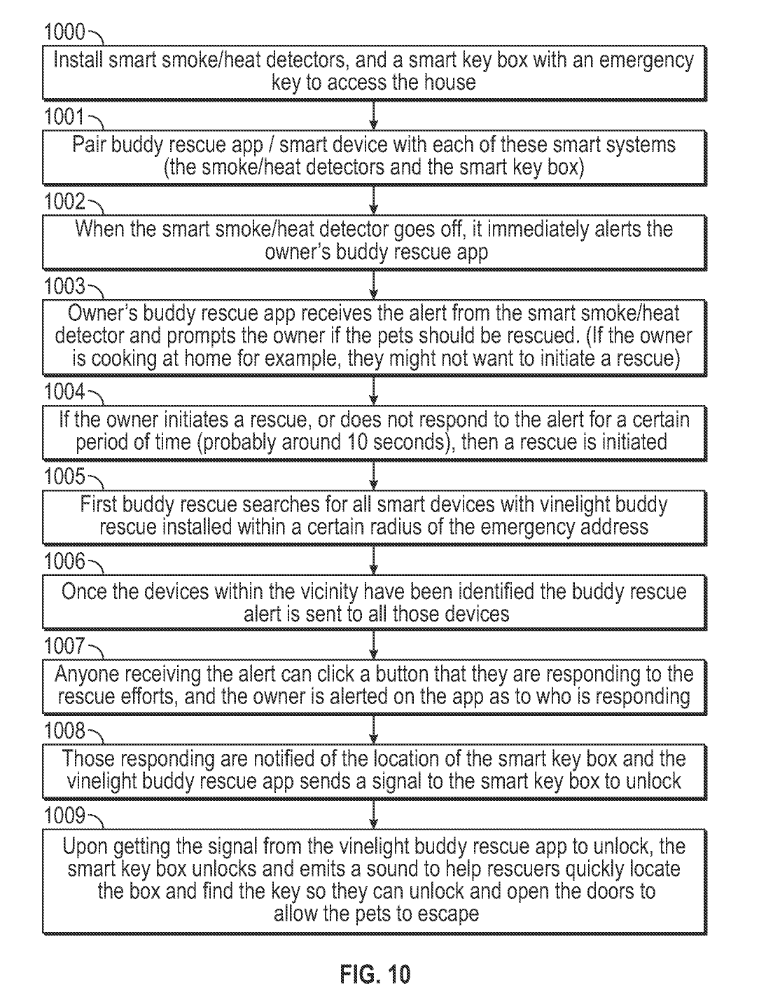

FIG. 10 is a flowchart of a process for using a pet emergency notification system with a smart key box to facilitate a pet rescue, in accordance with an exemplary embodiment. Steps 1000 through 1004 are substantially similar to steps 900 through 904 of FIG. 9, respectively, and therefore a detailed discussion of steps 1000 through 1004 will be omitted. However, steps 1000 and 1001 differ from steps 900 and 901 in that a smart key box is installed (step 1000) and paired (step 1001) with the Vinelight buddy rescue mobile application 300.

In step 1005, the Vinelight buddy rescue mobile application 300 searches for all devices having the Vinelight buddy rescue mobile application 300 installed that are within a predetermined radius of the emergency. In step 1006, the Vinelight buddy rescue mobile application 300 provides an alert to the devices within the predetermined radius. In step 1007, a user notified of the emergency may indicate on the Vinelight buddy rescue mobile application 300 that he or she is responding to the emergency. In step 1008, the responding users are notified via the Vinelight buddy rescue mobile application 300 of the location of the smart key box. The Vinelight buddy rescue mobile application 300 also transmits a signal to the smart key box to unlock the smart key box so the responding users can access a key to the home. In step 1009, the smart key box unlocks itself in response to the signal received from the Vinelight buddy rescue mobile application 300 and emits a sound to help responding users locate the key box.

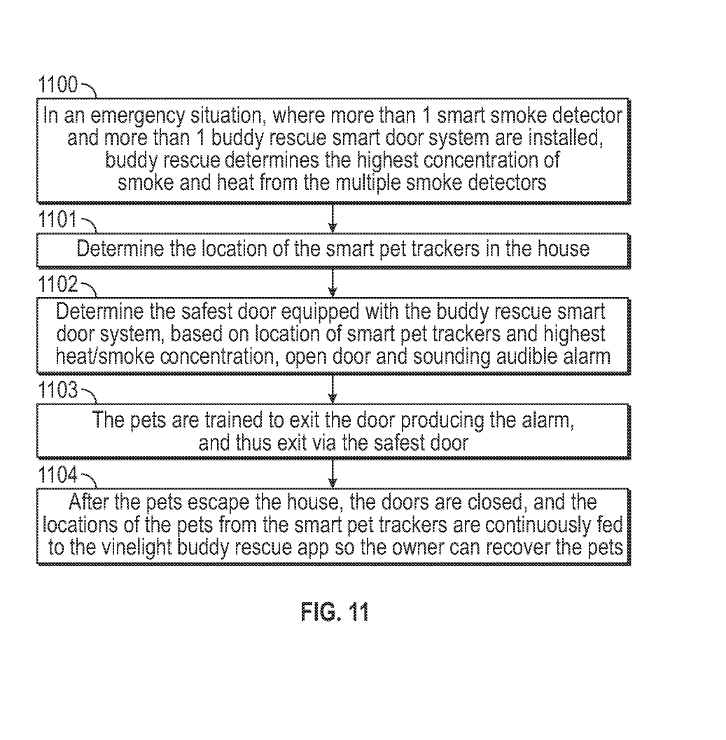

FIG. 11 is a flowchart of a process for using a pet emergency notification system with multiple smart smoke detectors to facilitate a pet rescue, in accordance with an exemplary embodiment. In the exemplary embodiment of FIG. 11, multiple smart smoke detectors and multiple smart door openers are installed in the home. In step 1100, when a smart smoke detector detects smoke, it transmits an alarm signal to the Vinelight buddy rescue mobile application 300, which may include an indication of the smoke and/or heat detected. In step 1101, the Vinelight buddy rescue mobile application 300 determines the location of the pet(s) based on a signal received from each smart pet tracker device installed on each pet's collar.

In step 1102, the Vinelight buddy rescue mobile application 300 determines the door equipped with a smart door opener that provides the safest escape route. The safest route is determined based on the pet's location and the smoke/heat intensity signal received from the smoke detectors. Once the safest door is determined, the Vinelight buddy rescue mobile application 300 transmits a signal to unlock the door using the smart door opener, which opens the door and emits an audible alarm. In step 1103, if the pet has been previously trained to exit the house upon hearing the audible alarm, the pet follows the sound of the alarm to the open door and exits the house. In step 1104, the Vinelight buddy rescue mobile application 300 monitors the location of the pet(s) by receiving signals from the smart pet tracker device on the pet's collar so that the owner may locate the pet. The Vinelight buddy rescue mobile application 300 also transmits a signal to the smart door opener to close the door once the pet has exited to prevent further ventilation.

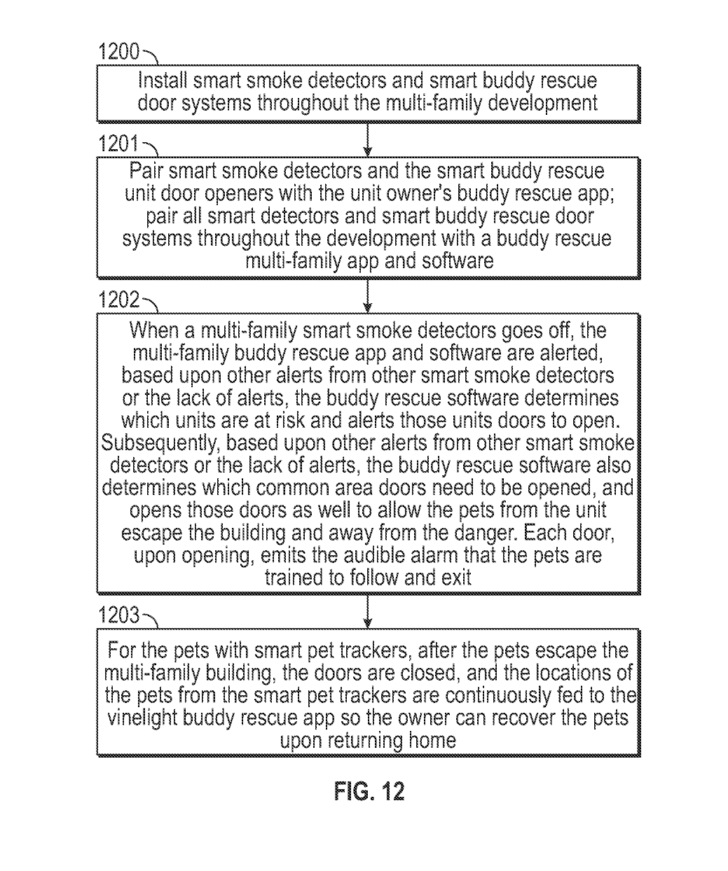

FIG. 12 is a flowchart of a process for using a pet emergency notification system in a multi-family development to facilitate a pet rescue, in accordance with an exemplary embodiment. In step 1200, smart smoke detectors and smart door opener systems are installed throughout the multi-family development. In step 1201, the owner's Vinelight buddy rescue mobile application 300 is paired with the smart smoke detectors and smart door openers installed in the owner's residence. All other smart smoke detectors and smart door openers may be paired with the Vinelight buddy rescue mobile application 300 on each owner's mobile device, or alternatively, a separate multi-family application may be used that aggregates all of the owners who live in the facility and broadcasts alerts to each of them when any of the smart smoke detectors triggers an alarm.

In step 1202, one of the smart smoke detectors detects smoke and transmits a signal to the Vinelight buddy rescue mobile application 300, which may be an individual application or an application that all owners living in the facility receive. The Vinelight buddy rescue mobile application 300 determines, based on the smart smoke detectors from which it has received an alert, which units are in danger and transmits a signal to those smart door openers to unlock and open the doors to the units in danger. The Vinelight buddy rescue mobile application 300 also determines which common area doors need to be unlocked and opened to allow the pets to escape, and sends a signal to those smart door openers to unlock and open the necessary common area doors. Each door that is opened emits an audible alarm to guide the pet's exit.

In step 1203, the smart pet tracker devices located on each pet's collar transmits a signal to the Vinelight buddy rescue mobile application 300 indicating the pet's location. Once the pet is determined to be outside of the multi-family facility, the Vinelight buddy rescue mobile application 300 sends a signal to each of the opened doors that causes the doors to close.

In addition, the pet emergency notification system of the exemplary embodiment may be used at an animal shelter, kennel, or other facility housing a large number of animals. Each of the crates used to house these animals may be equipped with a receiver and a mechanism for opening the door to the crate based on a signal received by the receiver. If a smart smoke detector detects a fire at the animal shelter, the smart smoke detector transmits a signal to the Vinelight buddy rescue mobile application 300, which may be installed on a device of one or more employees of the animal shelter. The Vinelight buddy rescue mobile application 300 or the smart smoke detector may transmit a signal to the receivers installed on each crate at the animal shelter, causing the doors of each crate to open, and allowing the animals to exit the building to safety.

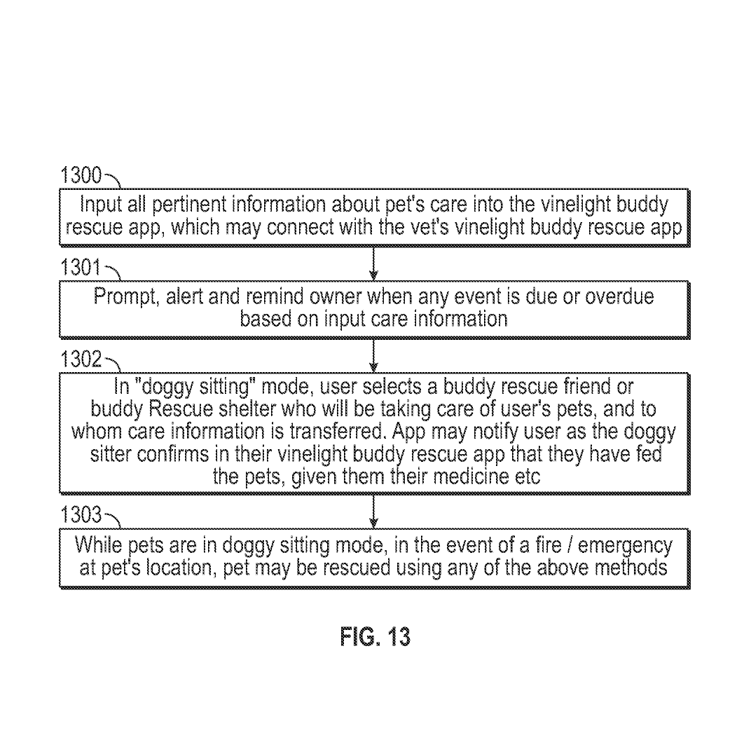

FIG. 13 is a flowchart of a process for using a pet emergency notification system in a pet sitting mode, in accordance with an exemplary embodiment. In step 1300, the user inputs pertinent information about a pet's care into the Vinelight buddy rescue mobile application 300. For example, the user may input any medications the pet is taking, the required dosage, and how frequently the pet needs to take the medication. In step 1301, the Vinelight buddy rescue mobile application 300 may alert the user and/or the pet owner when an event is due or overdue based on the input care information.

In step 1302, the user may enable a pet sitting mode on the Vinelight buddy rescue mobile application 300. Upon selecting this operation mode, the user can select another registered user of the Vinelight system that will be watching the pet. The designated user will then receive the care information via the Vinelight buddy rescue mobile application 300 installed on their mobile device. The Vinelight buddy rescue mobile application 300 may also prompt the designated user to confirm when various tasks relating to the pet have been completed, e.g., confirming that the pet has been given medication. The Vinelight buddy rescue mobile application 300 may then send a notification to the pet's owner informing the owner that task has been completed. In step 1303, because the Vinelight buddy rescue mobile application 300 is aware of the pet's location while in pet sitting mode, the Vinelight buddy rescue mobile application 300 may trigger a rescue as described in any of the above-described exemplary embodiments based on the pet's current location.

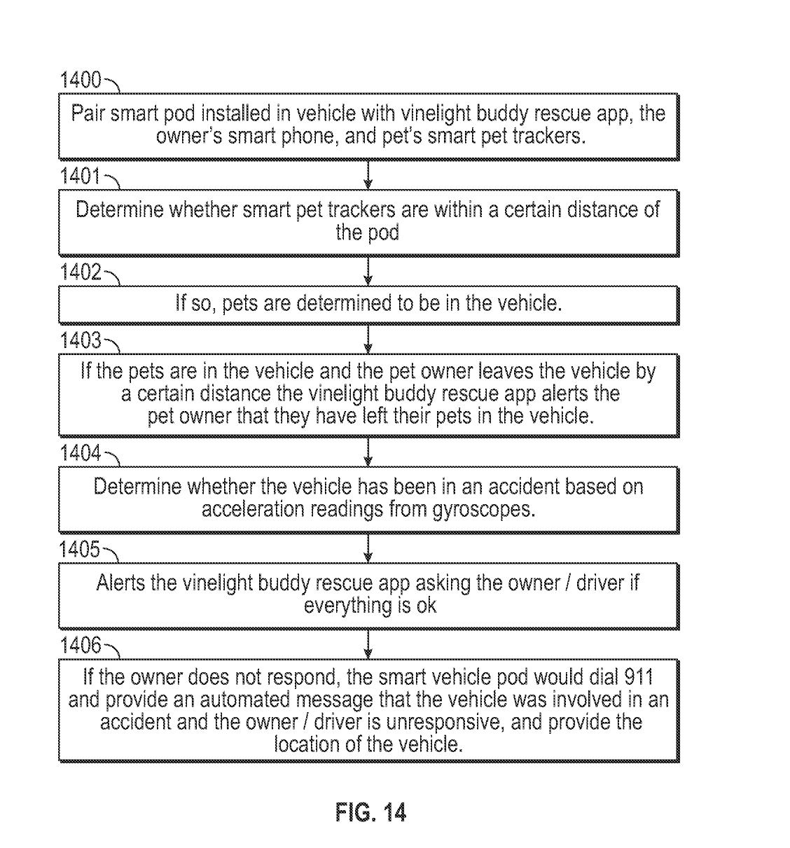

FIG. 14 is a flowchart of a process for using a smart pod for transporting pets in a vehicle with a pet emergency notification system, in accordance with an exemplary embodiment. The smart pod may be a kennel or crate that can be used to transport a pet in a vehicle, and that is able to communicate with other devices using various mediums and protocols. For example, the smart pod may communicate with other devices using Bluetooth, any of the 802.11 wireless standards, or any other wireless communication protocol. In step 1400, the smart pod that is installed in a vehicle is paired with the Vinelight buddy rescue mobile application 300 and the smart pet tracker located on the pet's collar. In step 1401, the Vinelight buddy rescue mobile application 300 or the smart pod determines whether the smart pet tracker is located within a predetermined distance from the smart pod, based on the signal received from the smart pet tracker. If the smart pet tracker is determined to be within the predetermined distance from the smart pod, in step 1403 the Vinelight buddy rescue mobile application 300 or the smart pod determines that the pet is inside the vehicle. In step 1403, if the pet is determined to be in the vehicle and the owner leaves the vehicle by more than a predetermined distance, the Vinelight buddy rescue mobile application 300 alerts the owner that the pet was left in the vehicle. This may be accomplished using, for example, the GPS signal from the owner's mobile device to determine the owner's distance from the vehicle. The smart pod may also include a thermometer that measures the temperature inside the vehicle. The smart pod may send alerts to the owner based on the vehicle temperature, if it determines that the pet is located in the vehicle. The frequency of the alerts may increase as the vehicle temperature approaches temperatures that are unsafe for the owner's pet. The smart pod may also send alerts to the vehicle owner's mobile application such that the alerts interrupt an ongoing phone call to ensure that the owner receives the alert. The smart pod may also be in communication with smart door openers equipped on the vehicle. If the smart pod determines that the pet is located in the vehicle and the vehicle temperature has reached an unsafe level, the smart pod may transmit a signal to the vehicle's smart door opener that causes the smart door opener to open the vehicle door and the door of the smart pod, allowing the pet to exit the vehicle.

In step 1404, the smart pod may include one or more gyroscopes that measures acceleration of the vehicle in which the smart pod is installed. If the smart pod detects a sufficiently large deceleration within a predetermined period of time, the smart pod determines that the vehicle has been in an accident. Alternatively, the smart pod may determine that the vehicle has been in an accident based on deployment of airbags in the vehicle, or a signal from any other sensor in the vehicle. In step 1405, when the smart pod has determined that the vehicle has been in an accident, the Vinelight buddy rescue mobile application 300 provides the owner with a message asking if the driver is injured. In step 1406, if the owner does not respond within a predetermined time period, or responds that the driver is injured, the smart vehicle pod and/or the Vinelight buddy rescue mobile application 300 would initiate a 911 call to report the accident. The report may be in the form of an automated voice that provides information regarding the emergency, such as the location, and a description of the owner and/or pet.

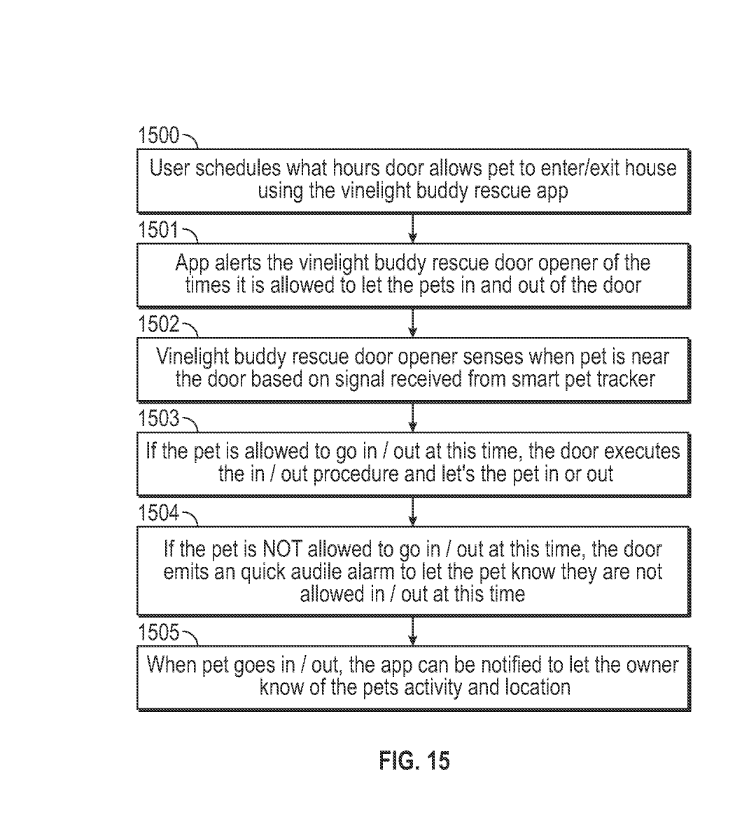

FIG. 15 is a flowchart illustrating a process of using the pet emergency notification system as an automated pet door, according to an exemplary embodiment. In step 1500, the user may input into the Vinelight buddy rescue mobile application 300 a schedule specifying when the pet is allowed to enter or exit the house using a smart door opener. In step 1501, the Vinelight buddy rescue mobile application 300 transmits a signal containing the schedule information to the smart door opener. In step 1502, the smart door opener detects when the pet is near the door based on a signal received from the smart pet tracker device on the pet's collar. In step 1503, the smart door opener determines whether the pet is allowed to enter or exit the house based on the input schedule information. If the pet is permitted to enter or exit the house at that time, the smart door opener causes the door to open to allow the pet to enter or exit the house, and then closes the door once the pet has entered or exited the house. In step 1504, if the smart door opener determines that the pet is not allowed to enter or exit the house at that time, based on the schedule information, the smart door opener emits an audible alarm notifying the pet that the pet is not allowed to exit or enter the house at that time. In step 1505, when the pet enters or exits the house, the Vinelight buddy rescue mobile application 300 may notify the owner that the dog has entered or exited the house, and confirm that the door has been closed.

The various components described herein, such as the Vinelight server 120, the various smart home appliances, and the Vinelight buddy rescue mobile application 300 may be embodied as, but are not limited to, a software and/or hardware component, such as a Field Programmable Gate Array (FPGA) or an Application Specific Integrated Circuit (ASIC), which performs certain tasks. These components may advantageously be configured to reside in the addressable storage medium and to execute on one or more processors. Thus, these components may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components may be combined into fewer components or further separated into additional components. In addition, the components may be implemented so as to execute one or more Central Processing Units (CPUs) in a device.

Although the inventive concepts of the present disclosure have been described and illustrated with respect to exemplary embodiments thereof, it is not limited to the exemplary embodiments disclosed herein and modifications may be made therein without departing from the scope of the inventive concepts.

What is claimed is:

1. A system comprising:
an emergency server configured to receive emergency information including address information corresponding to a reported emergency; and
an emergency database that stores registered user information;
wherein upon receipt of emergency information including address information corresponding to a reported emergency, the emergency server queries the emergency database to determine whether any registered user information contains an address that matches the address information contained in the received emergency information; and
wherein if the emergency server determines that an address contained in the registered user information matches the address information contained in the received emergency information, the emergency server provides an emergency notification to a user associated with the address.

2. The system of claim 1, wherein the emergency server receives the emergency information from an emergency dispatch system.

3. The system of claim 2, wherein the emergency dispatch system comprises a dispatch database that stores emergency reports, and a database monitoring unit that monitors the dispatch database for new emergency reports;
wherein the database monitoring unit is configured to transmit the emergency information to the emergency server upon detection of a new emergency report stored in the dispatch database.

4. The system of claim 2, wherein the emergency dispatch system comprises a dispatch database that stores emergency reports, and a database monitoring unit;
wherein, when a new emergency report is received by the emergency dispatch system, the new emergency report is transmitted to the dispatch database and the database monitoring unit substantially simultaneously.

5. The system of claim 1, further comprising:
a mobile application configured to be installed on a user's device and to communicate with the emergency server;
wherein the emergency notification is provided to a user associated with the address via the mobile application installed on the user's device.

6. The system of claim 5, wherein the mobile application comprises a graphical user interface that allows a user to transmit emergency information to the emergency server.

7. The system of claim 6, wherein the graphical user interface of the mobile application provides a plurality of options for a user to select from that describes the emergency the user intends to report.

8. The system of claim 6, wherein upon receipt of emergency information from the mobile application, the emergency server transmits emergency information to an emergency dispatch system that dispatches rescue personnel.

9. The system of claim 5, wherein the emergency server searches for all devices having the mobile application installed thereon and that are located within a predetermined radius of the address; and
wherein the emergency server sends a rescue alert to all devices having the mobile application installed thereon and determined to be located within the predetermined radius of the address.

10. The system of claim 9, wherein the mobile application installed on each device that receives the rescue alert provides an option for the user of each device to indicate that the user is responding to the rescue alert; and
wherein, if one or more users indicates that the user is responding to the rescue alert, the emergency server initiates a group chat session in which the one or more responding users and the user associated with the address may communicate.

11. The system of claim 9, wherein the rescue alert comprises at least one of: the address contained in the registered user information that matches the address information contained in the received emergency information, pet information stored in the emergency database that relates to one or more pets associated with the address, and one or more photographs of at least one building located at the address.

12. An emergency notification system comprising:
a mobile application configured to be installed on a user's device; and
one or more smart detectors installed in a dwelling and configured to detect at least one of heat and smoke, and configured to communicate with the mobile application of the user associated with the dwelling;
wherein, if the one or more smart detectors detects a fire, the one or more smart detectors transmits a rescue alert to the mobile application of the user associated with the dwelling.

13. The emergency notification system of claim 12, wherein upon receiving the rescue alert, the mobile application of the user associated with the dwelling searches for one or more smart pet tracker devices that indicates a pet location to determine whether one or more pets are located within the dwelling.

14. The emergency notification system of claim 13, wherein if the mobile application of the user associated with the dwelling determines that one or more pets are located within the dwelling, the mobile application transmits a signal to one or more smart door opener devices installed on one or more doors of the dwelling that causes the one or more smart door opener devices to open one or more doors to allow the one or more pets to exit.

15. The emergency notification system of claim 14, wherein the one or more smart door opener devices emits an audible alarm to notify the one or more pets of an exit route.

16. The emergency notification system of claim 14, wherein the mobile application of the user associated with the dwelling determines whether all of the one or more pets have exited the dwelling based on one or more signals received from the one or more smart pet tracker devices; and
wherein if the mobile application of the user associated with the dwelling determines that all of the one or more pets have exited the structure, the mobile application of the user associated with the dwelling transmits a signal to the one or more smart door opener devices to close one or more doors of the dwelling.

17. The emergency notification system of claim 13, wherein if the mobile application of the user associated with the dwelling determines that one or more pets are located within the dwelling, the mobile application transmits a signal to one or more smart kennel devices that causes the one or more smart kennel devices to unlock one or more kennel doors to allow the one or more pets to escape.

18. The emergency notification system of claim 12, wherein the mobile application of the user associated with the dwelling transmits a signal to a smart lockbox containing a key to access the dwelling, which causes the lockbox to unlock thereby providing access to the key; and
wherein the mobile application searches for devices of other users having the mobile application installed thereon that are located within a predetermined radius of the dwelling, and sends a notification of the lockbox location to all devices having the mobile application installed thereon and determined to be located within the predetermined radius of the dwelling.

19. The emergency notification system of claim 13, wherein the mobile application of the user associated with the dwelling determines a safe exit route based on a signal received from the one or more smart detectors and a signal received from one or more smart pet tracker devices, and transmits a signal to one or more smart door opener devices installed on one or more doors of the dwelling that causes the one or more smart door opener devices to open one or more doors to allow the one or more pets to exit in accordance with the determined safe exit route.

20. The emergency notification system of claim 12, wherein the mobile application searches for all devices having the mobile application installed thereon and that are located within a predetermined radius of the dwelling; and
wherein a rescue alert is sent to all devices having the mobile application installed thereon and determined to be located within the predetermined radius of the dwelling.

21. The emergency notification system of claim 20, wherein the mobile application transmits a signal to one or more smart door opener devices installed on one or more doors of the dwelling that causes the one or more smart door opener devices to unlock one or more doors of the dwelling.

22. The emergency notification system of claim 12, wherein, if the one or more smart detectors detects a fire, the one or more smart detectors transmits a rescue alert to a second mobile application configured to receive alerts from the one or more smart detectors.

23. An emergency notification system comprising:
a group mobile application configured to be installed on devices of users residing in a multi-unit dwelling; and
a plurality of smart detectors installed in a plurality of units in the multi-unit dwelling, which are configured to detect at least one of heat and smoke, wherein said plurality of smart detectors are configured to communicate with the group mobile application;
wherein, if one or more smart detectors detects a fire, the one or more smart detectors transmits a rescue alert to the group mobile application.

24. The emergency notification system of claim 23, wherein upon receiving the rescue alert, the group mobile application determines which units in the multi-unit dwelling are at risk, and transmits a signal to one or more smart door opener devices installed on one or more doors of the units determined to be at risk causing the one or more smart door opener devices to open the one or more doors.

25. The emergency notification system of claim 24, wherein the group mobile application determines one or more doors in common areas of the multi-unit dwelling that need to be opened in order to enable escape from the multi-unit dwelling, and transmits a signal to one or more smart door opener devices installed on the one or more doors in common areas of the multi-unit dwelling that causes said one or more doors in the common areas of the multi-unit dwelling to open.

26. A pet care notification system comprising:
a mobile application configured to be installed on a user's device and to receive information relating to caring for one or more of the user's pets; and
a pet care database that stores the information relating to caring for one or more of the user's pets;
wherein the mobile application notifies the user when a task is due or overdue based on the information relating to caring for the one or more pets.

27. The pet care notification system of claim 26, wherein the mobile application is configured to allow a user to designate a caretaker of the one or more pets associated with the user;
wherein, the information relating to caring for the one or more pets associated with the user is accessible by the mobile application installed on a device of the caretaker.

28. The pet care notification system of claim 26, wherein the information relating to caring for one or more pets is received from a medical provider of the one or more pets.

29. A pet safety system comprising:
a mobile application configured to be installed on a user's device;
a vehicle monitoring device installed in the user's vehicle that monitors acceleration of the user's vehicle;
wherein the mobile application comprises a module configured to communicate with the vehicle monitoring device, and to communicate with one or more smart pet tracker devices that indicates a pet location;
wherein, the mobile application determines whether one or more pets are located in the user's vehicle based on a signal received from the one or more smart pet tracker devices; and
wherein, if the mobile application determines that one or more pets is located in the vehicle, the mobile application alerts the user that the one or more pets is located in the vehicle if the mobile application determines that the user is more than a predetermined distance away from the vehicle.

30. The pet safety system of claim 29, wherein the mobile application determines that the vehicle has been in an accident based on a signal received from the vehicle monitoring device, and prompts the user to indicate whether emergency personnel should be contacted.

31. The pet safety system of claim 30, wherein, if the user does not respond to the prompt within a predetermined time period, the mobile application transmits a signal requesting assistance to an emergency dispatch system.

32. An automated pet door system comprising:
a pet mobile application installed on a user's device; and
one or more smart door opener devices installed on one or more doors at the user's residence, and configured to automatically open the one or more doors;
wherein the pet mobile application comprises:
a module configured to allow the user to specify a schedule according to which the user's pet is allowed to enter or exit the one or more doors at the user's residence; and
a module configured to communicate said schedule to the one or more smart door opener devices;
wherein the one or more smart door opener devices opens one or more doors in accordance with said schedule.

33. The automated pet door system of claim 32, wherein the one or more smart door opener devices are configured to receive a signal from a smart pet tracker device indicating a location of the user's pet;
wherein, the one or more smart door opener devices determine whether the user's pet is within a predetermined distance of one or more doors on which the one or more smart door opener devices are installed; and
wherein, if the one or more smart door opener devices determines that the user's pet is within the predetermined distance of one or more doors on which the one or more smart door opener devices are installed, the one or more smart door opener devices open one or more doors if the user's pet is permitted to enter or exit the one or more doors according to the schedule.

34. The automated pet door system of claim 33, wherein the one or more smart door opener devices emits an audible alarm if the user's pet is within the predetermined distance of the one or more doors and the user's pet is not permitted to enter or exit the one or more doors according to the schedule.

35. The automated pet door system of claim 33, wherein the mobile application further comprises a module configured to communicate with the smart pet tracker device and receive pet location information therefrom; and
wherein, the mobile application is configured to inform the user of the location of the user's pet based on received pet location information.
